(19) United States
(12) Patent Application Publication
(10) Pub. No.: US 2016/0123428 A1
(43) Pub. Date: May 5, 2016

(54) GEAR TRAIN LAYOUT STRUCTURE FOR DRIVING A FUEL PUMP

(71) Applicant: Hyundai Motor Company, Seoul (KR)

(72) Inventors: Jae Kyu Lee, Hwaseong-si (KR); Ahn Lee, Seoul (KR); Se Eun Kim, Hwaseong-si (KR)

(73) Assignee: Hyundai Motor Company, Seoul (KR)

(21) Appl. No.: 14/724,214

(22) Filed: May 28, 2015

(30) Foreign Application Priority Data
Oct. 29, 2014 (KR) 10-2014-0148644

(51) Int. Cl. F16F 15/26; F02M 37/04

(52) U.S. Cl. CPC F16F 15/265; F02M 37/041

(57) ABSTRACT

A gear train layout structure may include a fuel pump configured to pressurize fuel and to supply the pressurized fuel to an engine, a pump shaft, a driven gear for rotating the pump shaft, a driving gear to drive the driven gear, a first balance shaft and a second balance shaft respectively mounted at a front and a rear of a crankshaft of the engine for balancing the engine and attenuating vibration of the engine, a first balance gear and a second balance gear, a crank gear fixedly mounted on a side portion of the crankshaft, and at least one connecting rod connecting the crankshaft and a piston for rotating the crankshaft.

### CROSS-REFERENCE TO RELATED APPLICATION

The present application claims priority to Korean Patent Application Number 10-2014-0148644 filed Oct. 29, 2014, the entire contents of which is incorporated herein for all purposes by this reference.

### BACKGROUND OF INVENTION

1. Field of the Invention

The present invention relates to a gear train layout structure. More particularly, the present invention relates to a gear train layout structure for driving a fuel pump.

2. Description of Related Art

In general, a crankshaft is precisely designed for balancing vibration that may occur due to reciprocal motion of pistons in engine cylinders. In order to balance the vibration, the crankshaft may be provided with a balance weight on an opposite side of a crank arm.

Even though most of the engine vibration is absorbed by the balance weight of the crankshaft, the engine vibration may not be completely eliminated. Consequently, in order to balance remaining vibration of the engine, the crankshaft may have a flywheel mounted to one side thereof, and a vibration damper mounted to the other side thereof. The vibration damper attenuates torsional vibration of the crankshaft. Along with this, the engine may have a balance shaft module (BSM) additionally mounted thereto for attenuating the vibration.

The balance shaft module typically consists of two shafts parallel to each other and mounted parallel to the crankshaft. The two shafts have sprockets or gears provided thereto. At least one of the sprockets or gears may be connected with and driven by the crankshaft. The two shafts rotate in opposite directions to each other. The two shafts of the balance shaft module have balance weights provided thereto for balancing the engine vibration by rotation of the balance weights.

Further, in the related art, a gear is mounted to a rear side of the engine in a length direction thereof for driving a fuel pump. Consequently, because mounting of a timing chain and a timing chain cover to the rear side of the engine in a length direction thereof is required, a problem of an engine length increase occurs. The engine length increase may deteriorate utilization of an engine compartment. Accordingly, there has been a requirement for reducing the engine length.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a gear train layout structure having an advantage of reducing an engine length, facilitating a reduction in engine length for solving a problem of a small engine compartment, as well as providing gear driving of a fuel pump.

According to various aspects of the present invention, a gear train layout structure may include a fuel pump configured to pressurize fuel and to supply the pressurized fuel to an engine, a pump shaft mounted to the fuel pump configured to pressurize the fuel, a driven gear fixedly mounted on a side portion of the pump shaft for rotating the pump shaft, a driving gear engaged with the driven gear to drive the driven gear, a first balance shaft and a second balance shaft respectively mounted at a front and a rear of a crankshaft of the engine parallel to the crankshaft for balancing the engine and attenuating vibration of the engine, a first balance gear and a second balance gear respectively fixedly mounted on side portions of the first balance shaft and the second balance shaft, a crank gear fixedly mounted on a side portion of the crankshaft, and at least one connecting rod connecting the crankshaft and a piston for rotating the crankshaft, in which the first balance shaft and the second balance shaft may be respectively driven as the first balance gear and the second balance gear may be driven by the crank gear, and the driving gear may comprise double columns together with the first balance gear or the second balance gear by the driving gear being fixedly mounted on the first balance shaft or the second balance shaft.

The gear train layout structure may further include an idle gear mounted between the first balance gear or the second balance gear and the crank gear.

The fuel pump may be mounted to a left side of the engine in a length direction thereof, and the driving gear may be mounted on the second balance shaft.

According to various aspects of the present invention, a gear train layout structure may include a fuel pump configured to pressurize fuel and to supply the pressurized fuel to an engine, a pump shaft mounted to the fuel pump configured pressurize the fuel, a driven gear fixedly mounted on a side portion of the pump shaft for rotating the pump shaft, a first balance shaft and a second balance shaft respectively mounted at a front and a rear of a crankshaft of the engine parallel to the crankshaft for balancing the engine and attenuating vibration of the engine, a first balance gear and a second balance gear respectively fixedly mounted on side portions of the first balance shaft and the second balance shaft, a crank gear fixedly mounted on a side portion of the crankshaft, and at least one connecting rod connecting the crankshaft and a piston for rotating the crankshaft, in which the first balance shaft and the second balance shaft are respectively driven as the first balance gear and the second balance gear are driven by the crank gear, and the driven gear is driven as the driven gear is engaged with, and rotated by, the first balance gear or the second balance gear.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a perspective view showing an exterior appearance and a direction of an engine having an exemplary gear train layout structure according to the present invention.

FIG. 2A, FIG. 2B and FIG. 2C illustrate a perspective view, a front view, and an enlarged view of an exemplary gear train layout structure according to the present invention.

FIG. 3A and FIG. 3B illustrate a perspective view, a front view, and an enlarged view of an exemplary gear train layout structure according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

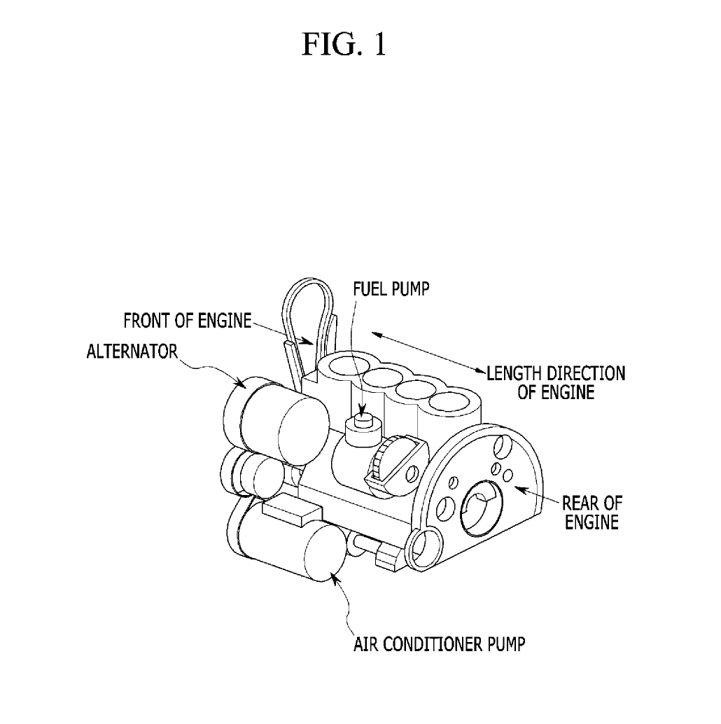

FIG. 1 illustrates a perspective view showing an exterior appearance and a direction of an engine having a gear train layout structure according to various embodiments of the present invention.

Referring to FIG. 1, in the engine having a gear train layout structure in accordance with various embodiments of the present invention, an alternator, an air conditioner pump, and so on are driven by a chain or a belt positioned on a front side of the engine, and a fuel pump is driven by a chain or a belt positioned on a rear side of the engine. In this case, the chain and chain cover mounted for driving the fuel pump cause an increase in length of the engine to the rear side of the engine, causing a problem in which available engine compartment space becomes smaller.

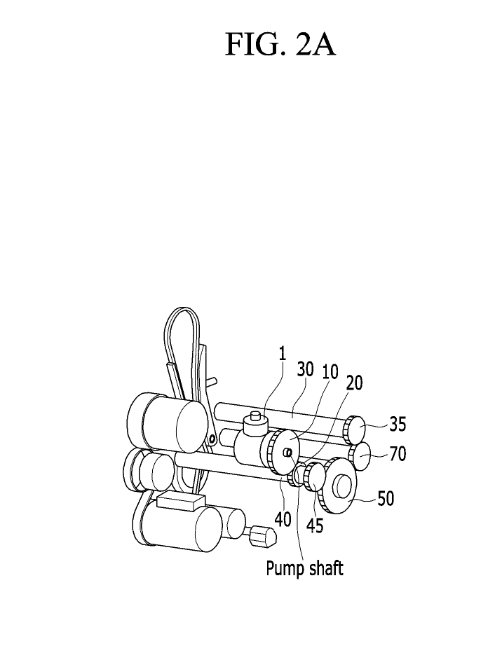

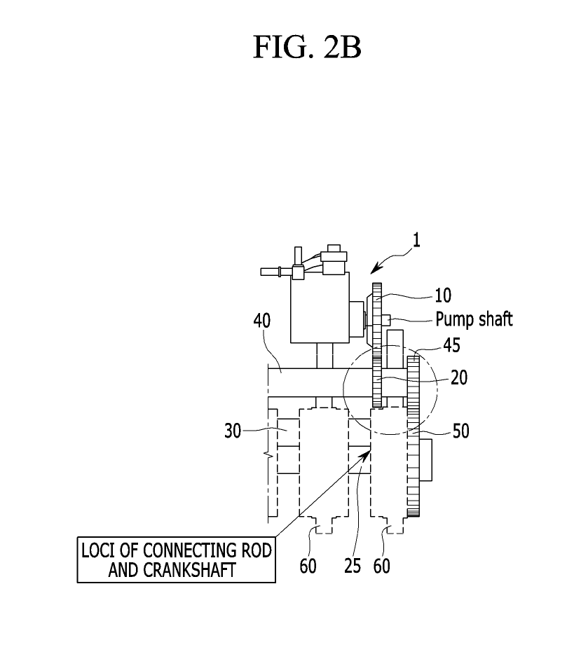

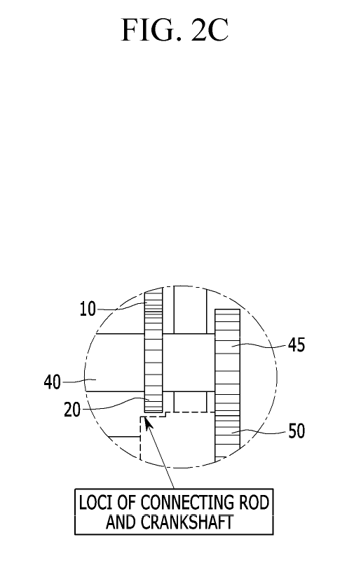

FIG. 2A, FIG. 2B, and FIG. 2C illustrate a perspective view, a front view, and an enlarged view of a gear train layout structure in accordance with various embodiments of the present invention.

In order to solve the above problem, a gear train layout structure in accordance with various embodiments of the present invention may be provided. With this, the problem of the small engine compartment space may be solved, and an additional advantage of gear driving may be provided. For an example, the additional advantages may be precision improvement of fuel pump control or durability improvement of a fuel pump driving system.

Moreover, since the gear train layout structure requires no additional shaft by utilizing a currently existing balance shaft module (BSM), cost may also be saved.

Referring to FIG. 2A, FIG. 2B, and FIG. 2C, the gear train layout structure in accordance with various embodiments of the present invention may include a fuel pump 1 for applying pressure to fuel to supply the fuel to an engine, a pump shaft mounted to the fuel pump 1 for applying the pressure to the fuel, a driven gear 10 fixedly mounted to one side of the pump shaft for rotating the pump shaft, a driving gear 20 engaged with the driven gear 10 to drive the driven gear 10, a first balance shaft 30 and a second balance shaft 40 respectively mounted to a front and a rear of a crankshaft 25 of the engine parallel thereto for balancing the engine and attenuating vibration of the engine, a first balance gear 35 and a second balance gear 45 fixedly mounted to one side portion of the first balance shaft 30 and the second balance shaft 40, respectively, a crank gear 50 fixedly mounted on one side portion of the crankshaft 25, and at least one connecting rod 60 connected between the crankshaft 25 and a piston (not shown) for rotating the crankshaft 25.

In the gear train layout structure, the first balance shaft 30 and the second balance shaft 40 are driven as the first balance gear 35 and the second balance gear 45 are driven by the crank gear 50, and as the driving gear 20 is fixedly mounted to the first balance shaft 30 or the second balance shaft 40, the driving gear 20 may construe a second train together with the first balance gear 35 or the second balance gear 45.

FIG. 2A, FIG. 2B, and FIG. 2C illustrate various embodiments in which the fuel pump 1 is mounted to a left side of the engine in a length direction thereof, and the driving gear 20 is mounted to the second balance shaft 40. However, the fuel pump 1 may be mounted to a right side of the engine in the length direction thereof, and the driving gear 20 may mounted to the first balance shaft 30.

Therefore, in the embodiments in FIG. 2A, FIG. 2B, and FIG. 2C, the driving gear 20 operates the fuel pump 1 by driving the driven gear 10 with a torque of the second balance shaft 40.

An enlarged drawing in FIG. 2C shows a connected state of the gears.

Referring to the enlarged drawing in FIG. 2C, the driving gear 20 may be mounted on the second balance shaft 40 on an inner side of the second balance gear 45. The second balance gear 45 is engaged with the crank gear 50 to drive the second balance shaft 40, and, according to this, the driving gear 20 drives the driven gear 10 in succession.

In this case, the driving gear 20 is placed at a position where the driving gear 20 does not interfere with rotating loci of the connecting rod 60 and the crankshaft 25. Further, a radius of the driving gear 20 may also be determined to not meet the loci.

The gear train layout structure in accordance with various embodiments of the present invention may further include an idle gear 70 mounted between the first balance gear 35 or the second balance gear 45 and the crank gear 50. FIG. 2A illustrates embodiments in which the idle gear 70 is mounted between the first balance gear 35 and the second balance gear 45.

In general, the idle gear 70 functions to make rotation directions of the first balance shaft 30 and the second balance shaft 40 opposite to each other. Since this is a general operation principle of the BSM, which is apparent to persons skilled in this field of art, detailed description thereof will be omitted.

However, in various embodiments illustrated in FIG. 2A-FIG. 2C, when the idle gear 70 is mounted between the second balance gear 45 and the crank gear 50, besides the aforementioned function, the idle gear 70 may also perform a function of preventing at least one connecting rod 60 from interfering with the driving gear 20.

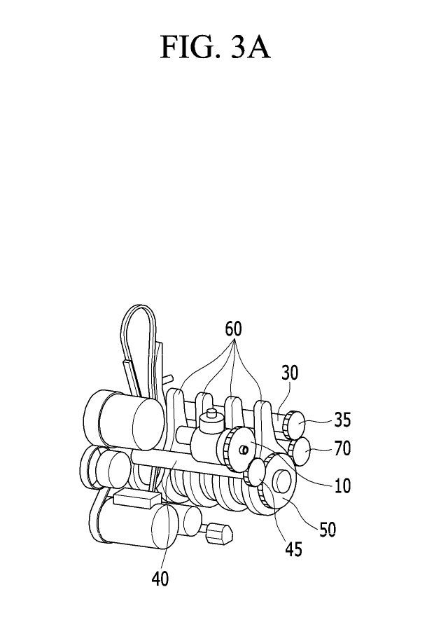

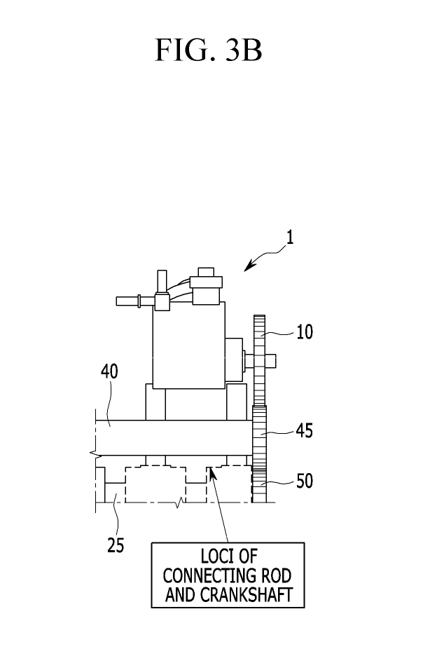

FIG. 3 illustrates a perspective view, a front view, and an enlarged view of a gear train layout structure in accordance with various embodiments of the present invention.

Referring to FIG. 3A and FIG. 3B, the gear train layout structure may include all elements of the aforementioned embodiments except the driving gear 20.

In this case, the first balance shaft 30 and the second balance shaft 40 may be driven while the first balance gear 35 and the second balance gear 45 are driven by the crank gear 50, and the driven gear 10 may be engaged with, and rotated by, the first balance gear 35 or the second balance gear 45. That is, the function of the driving gear 20 in the aforementioned embodiments may be made by the first balance gear 35 or the second balance gear 45. FIG. 3A and FIG. 3B illustrate embodiments in which the second balance gear 45 drives the driven gear 10. However, when the fuel pump 1 is mounted to a right side of the engine in the length direction thereof, the first balance gear 35 may be engaged with the driven gear 10 for operating the fuel pump 1.

Since the embodiments illustrated in FIG. 3 have no driving gear 20 provided separately, there is no problem of interference of the rotation loci of the connecting rod 60 and the crankshaft 25 with the driving gear 20.

Referring to FIG. 3A and FIG. 3B, the gear train layout structure may further include an idle gear 70 mounted between the first balance gear 35 or the second balance gear 45 and the crank gear 50. Since a function of the idle gear 70 is identical to the description made in the aforementioned embodiments, detailed description thereof will be omitted.

Thus, since the gear train layout structure of the present invention reduces the engine length, an engine compartment layout may be improved and the additional advantage of gear driving may be secured.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gear train layout structure comprising:
a fuel pump configured to pressurize fuel and to supply a pressurized fuel to an engine;
a pump shaft mounted to the fuel pump configured to pressurize the fuel;
a driven gear fixedly mounted on a side portion of the pump shaft for rotating the pump shaft;
a driving gear engaged with the driven gear to drive the driven gear;
a first balance shaft and a second balance shaft respectively mounted at a front and a rear of a crankshaft of the engine parallel to the crankshaft for balancing the engine and attenuating vibration of the engine;
a first balance gear and a second balance gear respectively fixedly mounted on side portions of the first balance shaft and the second balance shaft;
a crank gear fixedly mounted on a side portion of the crankshaft; and
at least one connecting rod connecting the crankshaft and a piston for rotating the crankshaft,
wherein the first balance shaft and the second balance shaft are respectively driven as the first balance gear and the second balance gear are driven by the crank gear, and
the driving gear comprises double columns together with the first balance gear or the second balance gear by the driving gear being fixedly mounted on the first balance shaft or the second balance shaft.

2. The gear train layout structure of claim 1, further comprising an idle gear mounted between the first balance gear or the second balance gear and the crank gear.

3. The gear train layout structure of claim 1, wherein the fuel pump is mounted to a left side of the engine in a length direction thereof, and the driving gear is mounted on the second balance shaft.

4. The gear train layout structure of claim 2, wherein the fuel pump is mounted to a left side of the engine in a length direction thereof, and the driving gear is mounted on the second balance shaft.

5. A gear train layout structure comprising:
a fuel pump configured to pressurize fuel and to supply a pressurized fuel to an engine;
a pump shaft mounted to the fuel pump configured to pressurize the fuel;
a driven gear fixedly mounted on a side portion of the pump shaft for rotating the pump shaft;
a first balance shaft and a second balance shaft respectively mounted at a front and a rear of a crankshaft of the engine parallel to the crankshaft for balancing the engine and attenuating vibration of the engine;
a first balance gear and a second balance gear respectively fixedly mounted on side portions of the first balance shaft and the second balance shaft;
a crank gear fixedly mounted on a side portion of the crankshaft; and
at least one connecting rod connecting the crankshaft and a piston for rotating the crankshaft,
wherein the first balance shaft and the second balance shaft are respectively driven as the first balance gear and the second balance gear are driven by the crank gear, and
the driven gear is driven as the driven gear is engaged with, and rotated by, the first balance gear or the second balance gear.

6. The gear train layout structure of claim 5, further comprising an idle gear mounted between the first balance gear or the second balance gear and the crank gear.

7. The gear train layout structure of claim 5, wherein the fuel pump is mounted to a left side of the engine in a length direction thereof, and the driving gear is mounted on the second balance shaft.

8. The gear train layout structure of claim 6, wherein the fuel pump is mounted to a left side of the engine in a length direction thereof, and the driving gear is mounted on the second balance shaft.
